(19) United States
(12) Patent Application Publication
(10) Pub. No.: US 2022/0242801 A1
(43) Pub. Date: Aug. 4, 2022

(54) MINERAL SOIL CONDITIONER PRODUCED BY COAL ASH AND PREPARATION METHOD THEREOF

(71) Applicant: SOUTH CHINA UNIVERSITY OF TECHNOLOGY, Guangzhou (CN)

(72) Inventor: Lin SHI, Guangzhou (CN)

(73) Assignee: SOUTH CHINA UNIVERSITY OF TECHNOLOGY, Guangzhou (CN)

(21) Appl. No.: 17/630,509

(22) PCT Filed: Oct. 27, 2019
(86) PCT No.: PCT/CN2019/113504

§ 371 Date: Jan. 27, 2022

(30) Foreign Application Priority Data
Jul. 27, 2019 (CN) 201910685346.2

(51) Int. Cl. C05G 3/80; C09K 17/04; C05D 3/00; C05D 1/00

(52) U.S. Cl. CPC C05G 3/80; C05D 1/005; C05D 3/00; C09K 17/04

(57) ABSTRACT

The present invention discloses a mineral soil conditioner produced by coal ash and a preparation method thereof. The preparation method includes: (1) mixing coal ash with a heteroacid to form a mixture, stirring and filtering the mixture under the action of ultrasound to obtain a refined coal ash and a filtrate; (2) mixing the refined coal ash obtained in the step (1) with a calcium-based compound and a potassium-based compound well, performing drying with the residual heat of tail gas of a kiln after granulation; (3) performing calcination and activation continuously after granulation and drying in the step (2), then cooling, and processing by ball milling and molding to obtain a novel mineral soil conditioner. The present invention achieves the efficient utilization of a fuel coal by-product, namely, coal ash in agriculture and reduces the heavy metal content in coal ash and environmental contamination caused thereby.

### TECHNICAL FIELD

The present invention relates to the technical field of agricultural resource utilization of coal ash, and in particular to a mineral soil conditioner produced by coal ash and a preparation method thereof.

### BACKGROUND

China is a great coal-producing country; coal accounts for more than ⅔ of the national energy capacity; the quantity of coal burnt per year is more than 3 billion tons. Calculated by the ratio that every 4 tons of coal produces 1 ton of coal ash, the total quantity of the coal ash produced every year is up to 120 million tons above. Therefore, coal ash has become the maximum single pollution source of industrial solid wastes in China. Coal ash enriches a large number of heavy metal substances endangering human health, such as, As, Pb, Cd, Cr and Hg, causing tremendous harm to the environment; additionally, low available nutrients limit the comprehensive utility efficiency of coal ash in agriculture. The pollution caused by coal ash is mainly manifested in the following aspects: (1) soil pollution: when heavy metal elements in coal ash get into soil and exceed the critical values, soil will output pollutants to the environment, such that other environmental elements are polluted; soil constitution, structure, functions and the like will change accordingly, finally leading to soil resource exhaustion and damage. The research results show that compared with the blank group, the experimental group applied with coal ash has an increased content of various heavy metals generally, and causes poor gas permeability of soil and drainage. (2) Water body pollution: coal ash gets into rivers and lakes along with rainwater overland runoff or wind to pollute surface water, and permeates into soil with rainwater to cause groundwater pollution. The more obvious pollution is to increase the pH value of water body as well as the increase of poisonous and harmful elements, such as, Cr and As; in addition, coal ash will block river channels if it is directly discharged. (3) Air pollution: due to fine particles, coal ash will produce flying dust under wind action in air storage; the height of the flying dust can be up to 40-50 m, which not only influences atmospheric visibility, but also causes serious damages on buildings, natural landscapes and other topography due to aggregated dust in humid environment. (4) Endangering human health: the pollution of coal ash on water resources, soil and air will directly influence people's health and daily life. Residents living in dust environment of high coal ash have very high morbidity in nasopharyngitis, upper respiratory infection and the like. Radioactive elements in coal ash will also influence human health. Therefore, to carry out the comprehensive utilization of coal ash, thus turning waste into wealth and turning the harm into a benefit, has become an important technical-economic policy in China's economic construction, and is also one of the technical problems to be solved urgently in coal power industry.

With fine particle size, developed pore, high specific surface area and strong water absorption, coal ash can improve soil texture, reduce volume weight, increase porosity, increase ground temperature, narrow expansion rate, and particularly improve physical properties of clayey soil. Moreover, coal ash is also beneficial to moisturization and soil moisture conservation, enhances microbial activity in soil and promotes nutrient conversion, such that water, fertilizer, air and heat trend to be coordinated, thereby creating good soil environment for crop growth. Field trials conducted by Henan Agricultural University and Institute of Soil and Fertilizers of Henan Academy of Agricultural Sciences on lime concretion black soil indicate that after coal ash is applied, the volume weight of soil is decreased, and the porosity is increased; with the increase of coal ash, the volume weight of soil reduces gradually and the soil porosity increases gradually; the correlation coefficient is respectively—0.97 and 0.98. The continuous observation on soil temperature indicates that coal ash has an obvious temperature improving effect on lime concretion black soil, in particular to the soil with a depth of 5 cm and 10 cm; the temperature improving effect enhances with the increase of coal ash. Determination on the water content of soil with a depth of 10 cm after sowing for 15 d indicates that compared with the control field, water content of the field applied with coal ash increases by 23.7-36.4%. Trials in the Kanpur region of India indicates that after 20 tons of coal ash are applied per hectare, the soil water conductivity increases to 0.55 mm/h from 0.076; and the soil stability index increases to 14.08 from 12.51. Trials on the soil improvement with coal ash in Nanchang Power Plant indicates that 6.5% weight ratio (ash-soil ratio) can decrease the volume weight of soil to 1.26 g/cm³ from 1.36 g/cm³. Moreover, coal ash can improve soil texture by increasing the number of the waterstable aggregates (>1 mm) in soil. Paddy pot experiment indicates that when 5000 kg coal ash are applied per Mu, physical clay particles (<0.01 mm) in clayey soil can decrease to 41.97% from 44.65%; the content of soil clay particles decreases with the increase of the ash application amount and shows a significant linear negative correlation. When the ash application amount per Mu is within 4000 kg, the soil porosity will decrease with the increase of ash application amount and shows a significant positive correlation. Determination of Northwest A&F University indicates that when 1.5 tons of coal ash are applied per Mu, the soil expansion ratio decreases to 4.99% from 7.1%, thus being beneficial to the prevention of soil loss. Studies from US Pennsylvania State and Delaware State indicate that coal ash can improve the water binding capacity of sandy soil and enhance the drought resistance ability. On the other hand, lots of large/moderate trace minerals, such as, Si, Al, Fe, Ca, Mg, K, Na, Ti, P, B, Cu, Mo, Zn and Mn contained in coal ash greatly benefit the promotion of soil nutrient content. Malanchuk studies of State University of New York indicate that when 224 tons of coal ash are applied per hectare at room temperature, the yield of lotus root increases significantly. Shanxi Province has applied 5-60 tons of ash per Mu on moisture soil; the average available phosphorus content of 94 determinations on soil applied with coal ash is 26.2 mg/kg and increases 35.1% compared with ash-free control soil (average value: 19.4 mg/kg). Coal ash is rich in boron and thus, is a good fertilizer source of oil crops; peanuts and soybean growing on the soil improved by coal ash have obviously increased yield and quality. A 5-year research project, namely, “assessment on coal ash as calcium and boron resources of fruit trees” has been conducted in Simcoe region of Ontario Canada since 1996. Coal ash is applied in combination with humic acid to improve the content of available silicon in soil. Jilin Institute of Agricultural Sciences has planted paddy on three kinds of soils; after 1.5-3 tons of coal ash are applied per Mu, the content of soil available silicon increases to 1.9, 2.0 and 7.4 mg/kg from 1.07, 0.52 and 1.4 mg/kg. The application of coal ash can improve the soil microbial activity. Albic soil test indicates that soybean has obviously enhanced microbial activity in the soil root layer from florescence to the period of seed maturity; bacteria, actinomycetes and fungi show a consistent growth trend, which is beneficial to promoting the humification process of peat and other organic components in soil, thus creating good soil environment conditions for the growth and development of crops. Northwest A&F University has applied 5-15 tons of coal ash per Mu on cinnamon soil and immature soil; compared with the control group, wheat yield increases 10.2%, and corn yield increases 8.4%. The field trial on salinized aquept improved by coal ash indicates that when 20 tons of coal ash are applied per hectare, paddy and wheat achieve a highly significant yield-increasing effect. Soybean pot experiment indicates that the application of coal ash can not only increase 5% yield, but also can improve the content of crude protein and fat in soybean. In recent years, a multi-element compound fertilizer is produced by coal ash and coal ash is magnetized or a compound fertilizer is produced after magnetization, which is concerned by more and more manufacturers. Coal ash contains many trace elements, such as, Zn, Cu, B, Mo and Fe and thus, can be made into a high-efficacy compound fertilizer. Coal ash has been utilized in Japan to produce a silicate fertilizer, for example, the coal ash potassium silicate fertilizer made by mixing coal ash with potassium hydroxide and granulation contains 20% K₂O, 35% SiO₂, 4% MgO, 0.1% B₂O₃ and 8% CaO. The fertilizer is freely soluble in acid but not soluble in water, free of moisture absorption, and will be not lost due to rainwater and has long fertilizer efficiency. Compared with the control group, the coal ash compound fertilizer produced by the Institute of Soil and Fertilizers of Henan Academy of Agricultural Sciences can enable wheat yield to increase 17.7-88%, corn yield to increase 26.5-67.2%, paddy yield to increase 2.8-25.6%, and peanut yield to increase 12-24.2%; compared with common compound fertilizers, the yield rate of each crop is within 2.0-13.5%. By field experiments, the multi-element coal ash compound fertilizer developed by Hefei University of Technology is superior to the equivalent nutrient of conventional fertilization, and also superior to the 25% low-concentration tri-element compound fertilizer, and the yield respectively increases 19.1% and 8.9%.

But there are the following problems in the agricultural action of coal ash: (1) excessive heavy metals. Coal ash contains heavy metal elements, such as, As, Hg, Cr, Cd and Pb, and these heavy metal elements always exceed the limit standards of heavy metals in the agricultural coal ash; a large number of coal ash are used in farmland to cause soil pollution, thus entering the human body through the food chain. (2) Low mineral active components. Coal ash contains lots of mineral elements, but the effectiveness is poor; nutrients in coal ash are almost completely insoluble in water; and its solubility in weakly acidic solution is not more than 20%, which greatly increases the application amount of coal ash in farmland.

### SUMMARY OF INVENTION

### Technical Problem

### Solution to Problem

### Effects of Invention

The present invention is put forward directed to low resource utilization efficiency and not enough advanced technical merit of the existing coal ash. The present invention provides a mineral soil conditioner produced by coal ash and a preparation method thereof. The method is summarized as follows: various heteroacid solvents are added into coal ash to dissolve heavy metal elements in the coal ash, and then a sodium sulfide solution is utilized to enable acid-soluble heavy metal ions to generate precipitates, such that the washed acidic heteroacid solvent is reused. The refined coal ash after being removed heavy metals is added with a calcium-based compound, a potassium-based compound and other substances, and then subjected to mixing, drying, calcination and activation, thus obtaining the mineral soil conditioner with Si, Ca, K and Mg as major mineral nutrients and with weak base properties.

Objective of the present invention is achieved by one of the following technical solutions:

A preparation method for a mineral soil conditioner produced by coal ash includes the following steps:

(1) mixing coal ash with a heteroacid well to form a mixture, stirring and filtering the mixture under the action of ultrasound to obtain a refined coal ash and a filtrate;

(2) mixing the refined coal ash obtained in the step (1) with a calcium-based compound and a potassium-based compound well, then performing drying after granulation; and

(3) performing calcination and activation continuously after granulation and drying, taking out and cooling, processing by ball milling or molding to obtain the above mineral soil conditioner.

Further, in the step (1), the heteroacid is a mixed acid of any two or more of humic acid, hydrochloric acid, hydrofluoric acid, sulfuric acid, nitric acid, perchloric acid, citric acid, formic acid, acetic acid or tartaric acid, and each acid has a concentration of 0.1-1 mol/L; the heteroacid may dissolve out heavy metals in coal ash and transform the same into water-soluble heavy metals; a solid-liquid mixing ratio of the coal ash to the heteroacid is 1:0.1-1:10 g/mL; the ultrasound time is 1-30 min.

Further, to remove heavy metals and recover the heteroacid, the method further includes a step of adding a sodium sulfide solution to the filtrate obtained in the step (1), then filtering after tempering and stirring, where, the heavy metal is removed in the form of a heavy metal sulfide; the sodium sulfide solution has a concentration of 0.1-5 mol/L, and pH=4.0-9.5 after tempering.

Further, the filtrate obtained after adding the sodium sulfide solution and filtering may be recycled for the second time; the heteroacid is supplemented to recover the concentration of the heteroacid in the step (1); stirring and filtering under the action of ultrasound in the step (1) are continuously performed to dissolve out the heavy metal in coal ash again, thus obtaining a refined coal ash.

Further, a filter residue containing heavy metals obtained after being precipitated by sodium sulfide and filtered is washed at least for 3 times, and then the filter residue serves as hazardous industrial solid wastes for landfill treatment, where a water content in the filter residue is limited to 40 wt % or below. The precipitation rate that the heavy metal is precipitated into the filter residue is up to 90% or above.

Further, the mass ratio of the water amount to the heavy metal sulfide precipitate, namely, the liquid/solid ratio is 0.1:1-1:10.

Further, in the step (1), the stirring rate is 50-200 r/min and the stirring time is 10-120 min.

Further, in the step (2), the calcium-based compound is a mixture of two or more of CaCO₃, Ca(OH)₂, CaCl₂) or CaMg[CO₃]₂; the potassium-based compound is KOH, KCl, K₂SO₄ or K₂CO₃; in the step (2), a filter residue filtered in the step (1), the calcium-based compound and the potassium-based compound have the following mixing mass fractions: 10%-70% filter residue filtered in the step (1), 10%-70% calcium-based compound and 10%-70% potassium-based compound.

Further, in the step (2), the mixing time of the filter residue obtained after suction filtration in the step (1), the calcium-based compound and the potassium-based compound is 10-120 min; before granulation, water is added until a water content of the filter residue obtained after suction filtration in the step (1), the calcium-based compound and the potassium-based compound reaches 5-8 wt %, and then the granulation begins; the particle size is 0.3-5.5 cm, and the drying time is 30-300 min, such that the materials are dried to a water content of 1.5 wt % below.

Further, in the step (3), the method includes: activating for 30-60 min and performing calcination at 800-1050° C., then taking out the mixture and cooling, and ball milling into a powdery mineral soil conditioner; or after cooling, continuously adding 5-8 wt % water for disk granulation into a particle mineral soil conditioner, the soil conditioner has a particle size of 0.3-5.5 cm.

In the acidic soil conditioner prepared by the above method, the water content is less than 2 wt %; citric acid-soluble silicon dioxide has a content of 15 wt % or above; citric acid-soluble calcium oxide has a content of 25 wt % above; citric acid-soluble potassium oxide has a content of 4 wt % above; citric acid-soluble magnesium oxide has a content of 2 wt % above; total active ingredients in the nutrient is not less than 80 wt %; and the pH value is 9-12.

Further, the obtained mineral soil conditioner has a particle diameter of 0.5-2 cm.

### Beneficial Effects of Invention

### Beneficial Effects

Compared with the prior art, the present invention has the following advantages and innovation points:

(1) the main raw material of this present invention is coal ash, a kind of industrial solid waste obtained after coal combustion; heavy metals contained in coal ash are extracted and residues are made into a mineral soil conditioner, which may reduce the heavy metal content in coal ash (the removal rate of heavy metal herein is up to 50% or above), being up to the limit standard value of agricultural coal ash, thus improving the efficient comprehensive utilization level of coal ash, relieving the heavy metal hazard of coal ash, improving the mineral content level and decreasing the use amount of farmland, thereby producing greater economic benefits;

(2) in this present invention, the refined coal ash obtained after removing heavy metals from coal ash is made into a mineral soil conditioner to achieve the secondary utilization of pollutants, which accords with the scientific idea of circular economy development and sustainable development;

(3) the mineral soil conditioner prepared herein contains lots of trace elements, such as, Si, Ca, Mg, K, Na and S, and is full of nutrients and can achieve the effect of balanced fertilization, thereby comprehensively promoting the mineral element content in soil and soil environment quality, decreasing the use amount of farmland, thereby producing greater economic benefits;

(4) the mineral soil conditioner product prepared herein is weakly alkaline, which has significant improvement and repairing effect on acid soil;

(5) the heavy metal is removed in the form of sulfides, namely, a stable state, and finally disposed by landfill; the heteroacid solvent may be reused, thereby achieving a production mode of green circulation economy.

### BRIEF DESCRIPTION OF DRAWINGS

### Description of Drawings

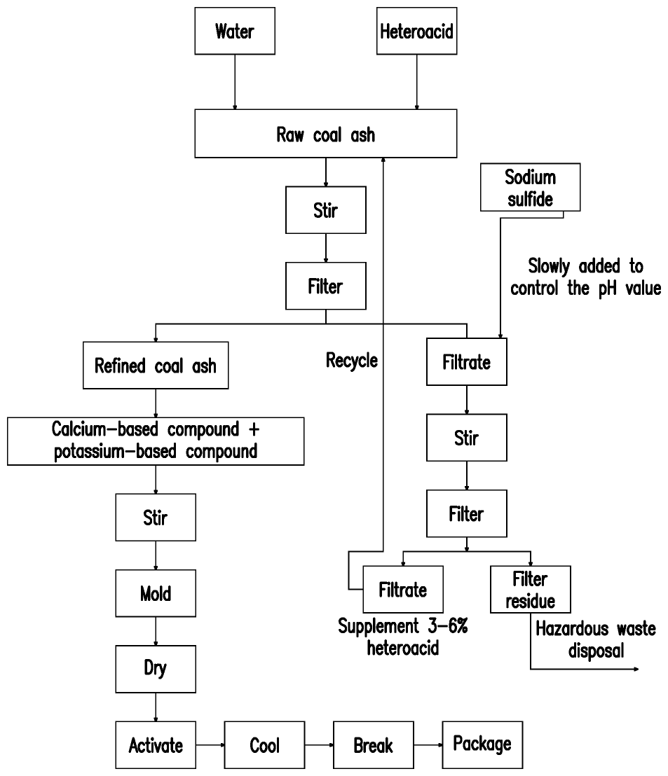

FIG. 1 is a schematic diagram showing a technical process of a mineral soil conditioner produced by coal ash in an example.

### DESCRIPTION OF EMBODIMENTS

### Embodiments of the Invention

The technical solution of the present invention will be further described in detail with reference to detailed examples and accompanying drawings, but the protection scope and embodiments of the present invention are not limited thereto.

FIG. 1 shows a schematic diagram showing a technical process of a mineral soil conditioner produced by coal ash in an example; the specific process flow is as follows:

Various acid pickling solutions are prepared, including humic acid, hydrochloric acid, sulfuric acid, nitric acid, perchloric acid, citric acid, formic acid, acetic acid, tartaric acid, and the like with a mixing concentration of 0.1-10 mol/L; the acid pickling solutions and coal ash are mixed, stirred and filtered to dissolve out and separate a heavy metal in coal ash, thus being up to the limit standard value of the heavy metal in agricultural coal ash. After separating the heavy metal, a filtrate containing the heavy metal and the coal ash after being removed the heavy metal, namely, refined coal ash are obtained. A sodium sulfide solution is added to the obtained filtrate containing the heavy metal to precipitate the heavy metal, and the heavy metal is filtered to obtain a filtrate; a portion of 3-6% (consumption) of heteroacid is supplemented to the filtrate for reuse; a filter residue containing the heavy metal sulfide may be used as hazardous solid wastes for disposal; a calcium-based compound and a potassium-based compound are added to the refined coal ash to be mixed well, dried, granulated, activated, cooled, broken and packaged, thus finally obtaining the mineral soil conditioner.

Coal ash is utilized to produce the mineral soil conditioner produced according to the process flow of FIG. 1.

### Example 1

A certain thermal power plant in Inner Mongolia had an annual output of 1 million tons of coal ash, of which, silicon dioxide had a content of 57.67 wt %, potassium oxide had a content of 0.42 wt %, aluminium oxide had a content of being up to 17.32 wt %, calcium oxide had a content of 2.15 wt %, and ferric oxide had a content of 1.35 wt %; the heavy metal content was as follows: Pb had a content of 121.73 mg/kg, Cd had a content of 2.15 mg/kg, Hg had a content of 0.74 mg/kg, and Cu had a content of 7.97 mg/kg.

The operation process was as follows:

(1) Coal ash was mixed with a mixed acid of humic acid, hydrochloric acid, sulfuric acid, nitric acid and perchloric acid having a concentration of 0.2 mol/L according to a solid/liquid ratio of 1:1 g/mL, and subjected to ultrasound treatment for 20 min, then stirred for 55 min by a stirrer at 85 r/min to be mixed evenly, and then filtered; the removal rate of heavy metals in the obtained coal ash was respectively: 67% Pb, 86% Cd, 66% Hg and 87% Cu.

(2) A sodium sulfide solution having a concentration of 0.15 mol/L was added to the filtrate filtered in the step (1), and the PH=5.5 after tempering. The product obtained in the above step was stirred for 85 min by a stirrer at 150 r/min and then filtered; the sulfide heavy metal residues were washed with fresh water for 3 times; the precipitation rate of Pb, Cd, Hg and Cu in the filtrate was up to 90% or above; the filtrate after being removed the heavy metals was supplemented with the heteroacid to recover the concentration of the heteroacid in the step (1) for recycling.

(3) Calcium carbonate, calcium hydroxide and potassium hydroxide were added to the filter residue of the refined coal ash filtered in the step (1); the mixing mass ratio was as follows: 45% filter residue obtained after suction filtration in the step (1), 25% calcium carbonate, 20% calcium hydroxide and 10% potassium hydroxide; after being stirred evenly, the above materials were dried for 70 min with a tail gas of a kiln; the dried sample was calcinated for 30 min at 900° C., and cooled to room temperature, then broken and sieved with 100 meshes to obtain a soil conditioner rich in mineral elements.

It can be seen from the detection of a third party that in the produced soil conditioner, there are 84.35 wt % total mineral nutrients, including 15.34 wt % available silicon dioxide, 26.87 wt % available calcium oxide, 5.82 wt % available magnesium oxide, 4.75 wt % available potassium oxide, and 2.74 wt % available sodium oxide; the pH value is 10.5; the produced soil conditioner is a soil conditioner containing multiple mineral nutrients.

### Example 2

A certain thermal power plant in Liaoning province had an annual output of 1.6 million tons of coal ash, of which, silicon dioxide had a content of 52.67 wt %, aluminium oxide had a content of being up to 21.76 wt %, potassium oxide had a content of 0.72 wt %, calcium oxide had a content of 3.15 wt %, and ferric oxide had a content of 3.57 wt %; the heavy metal content was as follows: Pb had a content of 101.30 mg/kg, Cd had a content of 1.71 mg/kg, Hg had a content of 0.78 mg/kg, and Cu had a content of 19.48 mg/kg.

The operation process was as follows:

(1) Coal ash was mixed with a mixed acid of humic acid, hydrochloric acid, sulfuric acid, hydrofluoric acid, nitric acid and perchloric acid having a concentration of 0.57 mol/L according to a solid/liquid ratio of 1:2.5 g/mL, and subjected to ultrasound treatment for 15 min, then stirred for 60 min by a stirrer at 150 r/min to be mixed evenly, and then filtered; the removal rate of heavy metals in the obtained coal ash was respectively: 78% Pb, 82% Cd, 49% Hg and 70% Cu.

(2) A sodium sulfide solution having a concentration of 0.25 mol/L was added to the filtrate filtered in the step (1), and a tempering solution was controlled to pH=6.7; then stirred for 25 min by a stirrer at 90 r/min and then filtered; the sulfide heavy metal residues were washed with fresh water for 3 times; the precipitation rate of Pb, Cd, Hg and Cu in the filtrate was up to 92% or above; the filtrate after being removed the heavy metals was supplemented with the heteroacid to recover the concentration of the heteroacid in the step (1) for recycling.

(3) Calcium chloride, dolomite and potassium carbonate were added to the filter residue of the refined coal ash filtered in the step (1); the mixing mass ratio was as follows: 35% filter residue obtained after suction filtration in the step (1), 35% calcium chloride, 20% dolomite and 10% potassium carbonate; after being stirred evenly, the above materials were dried for 45 min at 105° C.; the dried sample was calcinated for 2 h at 870° C., and cooled to room temperature, then broken and sieved with 100 meshes to obtain a soil conditioner rich in mineral elements.

It can be seen from the detection of a third party that in the produced soil conditioner, there are 82.01 wt % total mineral nutrients, including 17.98 wt % available silicon dioxide, 31.09 wt % available calcium oxide, 6.16 wt % available magnesium oxide, and 6.21 wt % available potassium oxide; the pH value is 11.1; the produced soil conditioner is a soil conditioner containing multiple mineral nutrients.

### Example 3

A certain thermal power plant in Hebei province had an annual output of 3 million tons of coal ash, of which, silicon dioxide had a content of 46.67 wt %, aluminium oxide had a content of being up to 15 wt %, potassium oxide had a content of 0.92 wt %, calcium oxide had a content of 6.15 wt %, and ferric oxide had a content of 2.71 wt %; the heavy metal content was as follows: Pb had a content of 71.73 mg/kg, Cd had a content of 1.13 mg/kg, Hg had a content of 1.07 mg/kg, and Cu had a content of 38.02 mg/kg.

The operation process was as follows:

(1) Coal ash was mixed with a mixed acid of humic acid, hydrochloric acid, sulfuric acid, hydrofluoric acid, acid and perchloric acid having a concentration of 0.9 mol/L according to a solid/liquid ratio of 1:5 g/mL, and subjected to ultrasound treatment for 27 min, then stirred for 115 min by a stirrer at 195 r/min to be mixed evenly, and then filtered; the removal rate of heavy metals in the obtained coal ash was respectively: 72% Pb, 73% Cd, 73% Hg and 79% Cu.

(2) A sodium sulfide solution having a concentration of 2 mol/L was added to the filtrate filtered in the step (1), and a tempering solution was controlled to pH=7.2; then stirred for 45 min by a stirrer at 77 r/min and then filtered; the sulfide heavy metal residues were washed with fresh water for 3 times; the precipitation rate of Pb, Cd, Hg and Cu in the filtrate was up to 91% or above; then landfill treatment was performed, and a water content in the filter residue was limited to 40 wt % or below; the filtrate after being removed the heavy metals was supplemented with the heteroacid to recover the concentration of the heteroacid in the step (1) for recycling.

(3) Calcium carbonate, magnesium hydroxide and potassium sulfate were added to the filter residue of the refined coal ash filtered in the step (1); the mixing mass ratio was as follows: 45% filter residue obtained after suction filtration in the step (1), 25% calcium carbonate, 16% magnesium hydroxide and 14% potassium sulfate; after being stirred evenly, the above materials were dried for 50 min at 105° C. with a tail gas of a kiln; the dried sample was calcinated for 30 min at 1000° C., and cooled to room temperature, then broken and sieved with 100 meshes to obtain a soil conditioner rich in mineral elements.

It can be seen from the detection of a third party that in the produced soil conditioner, there are 82.93 wt % total mineral nutrients, including 17.46 wt % available silicon dioxide, 31.04 wt % available calcium oxide, 8.12 wt % available magnesium oxide, 5.18 wt % available potassium oxide, and 1.94 wt % available sodium oxide; the pH value is 11.8; the produced soil conditioner is a soil conditioner containing multiple mineral nutrients.

The above examples are preferred embodiments of the present invention, and merely illustrative of the present invention, but not construed as limiting the present invention. Moreover, any alteration, replacement, combination, simplification, modification and the like made by a person skilled in the art without departing from the spirit and principle of the present invention shall be equivalent substitution mode, and shall fall within the protection scope of the present invention.

1. A method for producing a mineral soil conditioner with coal ash, comprising the following steps:
(1) mixing coal ash with a heteroacid to form a mixture, stirring and filtering the mixture under the action of ultrasound to obtain a refined coal ash and a filtrate;
(2) mixing the refined coal ash obtained in the step (1) with a calcium-based compound and a potassium-based compound well, then performing drying after granulation; and
(3) performing calcination and activation after granulation and drying, then cooling, and processing by ball milling or molding to obtain the mineral soil conditioner.

2. The method according to claim 1, wherein in the step (1), the heteroacid is a mixed acid of any two or more of humic acid, hydrochloric acid, hydrofluoric acid, sulfuric acid, nitric acid, perchloric acid, citric acid, formic acid, acetic acid or tartaric acid, and each acid has a concentration of 0.1-1 mol/L; a solid-liquid mixing ratio of the coal ash to the heteroacid is 1:0.1-1:10 g/mL; and the ultrasound time is 1-30 min.

3. The method according to claim 1, wherein the method further comprises a step of adding a sodium sulfide solution to the filtrate obtained in the step (1), then filtering after tempering and stirring, wherein, the sodium sulfide solution has a concentration of 0.1-5 mol/L, and pH=4.0-9.5 after tempering.

4. The method according to claim 1, wherein in the step (1), the stirring rate is 50-200 r/min and the stirring time is 10-120 min.

5. The method according to claim 1, wherein in the step (2), the calcium-based compound is a mixture of two or more of CaCO₃, Ca(OH)₂, CaCl₂ or CaMg[CO₃]₂; the potassium-based compound is KOH, KCl, K₂SO₄ or K₂CO₃; in the step (2), a filter residue obtained after filtering in the step (1), the calcium-based compound and the potassium-based compound have the following mixing mass fractions: 10%-70% filter residue obtained after filtering in the step (1), 10%-70% calcium-based compound and 10%-70% potassium-based compound.

6. The method according to claim 1, wherein in the step (2), before granulation, water is added until a water content reaches 5-6%, then the granulation begins, the particle size is 0.3-5.5 cm and the drying time is 30-300 min.

7. The method according to claim 1, wherein in the step (3), the method comprises: activating for 30-60 min and performing calcination at 800-1050° C., then taking out and cooling to room temperature, and ball milling into a powdery mineral soil conditioner; or after cooling to room temperature, continuously adding 5-8 wt % water for disk granulation into a particle mineral soil conditioner, wherein the soil conditioner has a particle size of 0.3-5.5 cm.

8. The method according to claim 3, wherein the filtrate obtained after adding the sodium sulfide solution and filtering can be recycled for the second time; the heteroacid is supplemented to recover the concentration of the heteroacid in the step (1); stirring and filtering under the action of ultrasound in the step (1) are continuously performed, thus extracting heavy metals to obtain a refined coal ash.

9. The method according to claim 3, wherein a filter residue containing heavy metals obtained after being precipitated by sodium sulfide and filtered is washed at least for 3 times, and then subjected to landfill treatment, wherein a water content in the filter residue is limited to 40 wt % or below.

10. The mineral soil conditioner prepared by the method of claim 1, wherein the mineral soil conditioner has a water content less than 2 wt %; citric acid-soluble silicon dioxide has a content of 15 wt % or above; citric acid-soluble calcium oxide has a content of 25 wt % above; citric acid-soluble potassium oxide has a content of 4 wt % above; citric acid-soluble magnesium oxide has a content of 2 wt % above; total active ingredients in the nutrient are not less than 80 wt %; and the pH value is 9-12.
